(19) United States
(12) Patent Application Publication
(10) Pub. No.: US 2005/0043853 A1
(43) Pub. Date: Feb. 24, 2005

(54) Terminal control device of vending machine

(75) Inventor: Hiroyuki Negishi, Isesaki-shi (JP)

Correspondence Address: BANNER & WITCOFF, 1001 G STREET N W, SUITE 1100, WASHINGTON, DC, 20001, US

(73) Assignee: Sanden Corporation, Isesaki-shi (JP)

(21) Appl. No.: 10/912,223

(22) Filed: Aug. 6, 2004

(30) Foreign Application Priority Data
Aug. 8, 2003 (JP) 2003-289572

(51) Int. Cl. G05B 19/42

(52) U.S. Cl. 700/214

(57) ABSTRACT

There is provided a terminal control device of a vending machine that includes storage means capable of electrical data rewrite, connects to a main control device in a master/slave communication system, and can rewrite a control program stored in the storage means using a writing device, wherein the terminal control device further includes disabling means for disabling a system reset signal output from the main control device.

### BACKGROUND OF THE INVENTION

The present invention relates to a control device of a terminal device (hereinafter referred to as a terminal control device) such as a bill identification device, a cash handling device, or a card reader/writer. More particularly, the present invention relates to a terminal control device of a vending machine that includes storage means capable of electrical data rewrite, connects to a main control device in a master/slave communication system, and can rewrite a control program stored in the storage means using a writing device.

A conventional terminal control device of a vending machine will be described. FIG. 1 is a schematic wiring diagram of internal communication lines of the vending machine. FIG. 2 is a circuit diagram of communication between a main control device and terminal control devices of the vending machine.

The terminal control devices 2 to 4 each connect to the main control device 1 via a connection terminal 11. The main control device 1 transmits a transmitted signal Txd, a synchronization signal Syn, and a power supply Vout to the terminal control, devices 2, 3, and 4 that are a bill identification device, a cash handling device, and a card reader/writer. The main control device 1 receives a transmitted signal of the terminal control devices 2 to 4 as a received signal Rxd. The Syn signal is transmitted for synchronization of top command transmission of the Txd signal.

The main control device 1 reduces the Syn signal from high to low a t1 time before a top command of the Txd signal as shown in FIG. 3 (A). Then, the Syn signal is kept low for a t2 time, and then returned to high. The terminal control devices 2 to 4 each include a system reset circuit 5 that resets their own CPU. As shown in FIG. 3 (A), as long as the Syn signal is kept low within the t2 time, a Reset signal output from the system reset circuit 5 is kept low, and the CPU of the terminal control devices 2 to 4 is not reset.

If the main control device 1 detects a failure in communication by, for example, no response from the terminal control devices 2 to 4, the main control device 1 reduces the Syn signal from high to low as shown in FIG. 3(B) independently of the synchronization of the top command transmission of the Txd signal, and keeps the Syn signal low for a t3 time longer than the t2 time. The terminal control devices 2 to 4 handle the Syn signal, which is kept low for more than the t2 time, as a system reset signal output from the main control device 1. In the terminal control devices 2 to 4, the Reset signal output from the system reset circuit 5 goes from low to high according to the system reset signal, and the CPU is reset. This causes initialization of a communication system.

A method of rewriting control programs of the terminal control devices 2 to 4 without the main control device 1 will be described. Here, as shown in FIG. 2, the case of rewriting the control program of the terminal control device 2 will be described. First, a writing device 100 is connected to a data rewrite terminal 6 of the terminal control device 2. Then, a new control program is transferred from the writing device 100 to the terminal control device 2 to rewrite the new control program into an old control program stored in a flash memory 7 included in the CPU.

After the writing device 100 is connected to the data rewrite terminal 6 of the terminal control device 2, and an update of the control program of the terminal control device 2 is started, even if the main control device 1 transmits a Syn signal as a synchronization signal to the terminal control device 2 before transmitting a Txd signal, the terminal control device 2 cannot receive the Syn signal or transmit a response signal to the Syn signal because the terminal control device 2 is rewriting its own control program. Because the terminal control device 2 does not respond to the Syn signal, the main control device 1 retransmits the Syn signal as the synchronization signal. If the terminal control device 2 does not respond to the retransmission, the main control device 1 finally determines that there is a failure in communication with the terminal control device 2, and transmits a Syn signal as a system reset signal.

A Reset signal output from the system reset circuit 5 of the terminal control devices 2 to 4 goes from low to high according to the system reset signal transmitted by the main control device 1. This causes the CPU of the terminal control devices 2 to 4 to be reset, and the rewriting of the control program of the terminal control device 2 is forcedly stopped. Thus, the control program of the terminal control device 2 represents only part of a top of the new control program. On the other hand, the old control program is erased by the writing device 100. This makes the terminal control device 2 inoperable thereafter. Under these circumstances, the terminal control devices 2 to 4 to be rewritten have to be separated from the main control device 1, when the control program of the terminal control devices 2 to 4 is rewritten.

### SUMMARY OF THE INVENTION

An object of the invention is to provide a terminal control device of a vending machine that can easily and reliably rewrite a control program of the terminal control device without a main control device.

In order to achieve the object, the invention proposes a terminal control device of a vending machine that includes storage means capable of electrical data rewrite, connects to a main control device in a master/slave communication system, and can rewrite a control program stored in the storage means using a writing device, wherein the terminal control device further includes disabling means for disabling a system reset signal output from the main control device. The invention also proposes a terminal control device of a vending machine including, instead of the disabling means, delay means for delaying generation of an effect of a system reset signal output from the main control device.

According to the invention, if the disabling means is operated to disable the system reset signal output from the main control device, or the delay means is operated to delay the generation of the effect of the system reset signal, when the writing device is connected to the terminal control device to rewrite the control program of the terminal control device, a CPU of the terminal control device is reset during the rewriting of the control program of the terminal control device, thus eliminating a possibility of making the terminal control device inoperable.

Other objects, configurations, and advantages of the invention will become apparent from the following detailed description.

### BRIEF DESCRIPTION OF THE DRAWINGS

FIG. 1 is a schematic wiring diagram of internal communication lines of a conventional vending machine;

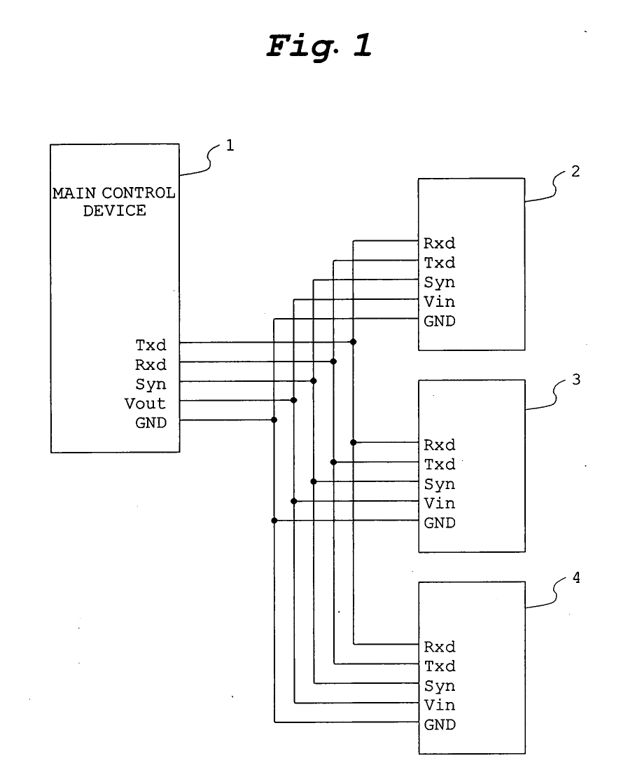

FIG. 2 is a circuit diagram of communication between terminal control devices and a main control device of the conventional vending machine;

FIGS. 3(A) and 3(B) are timing charts of communication between the conventional terminal control devices and the main control device, and FIG. 3(A) is a timing chart during normal operation and FIG. 3(B) is a timing chart at system reset;

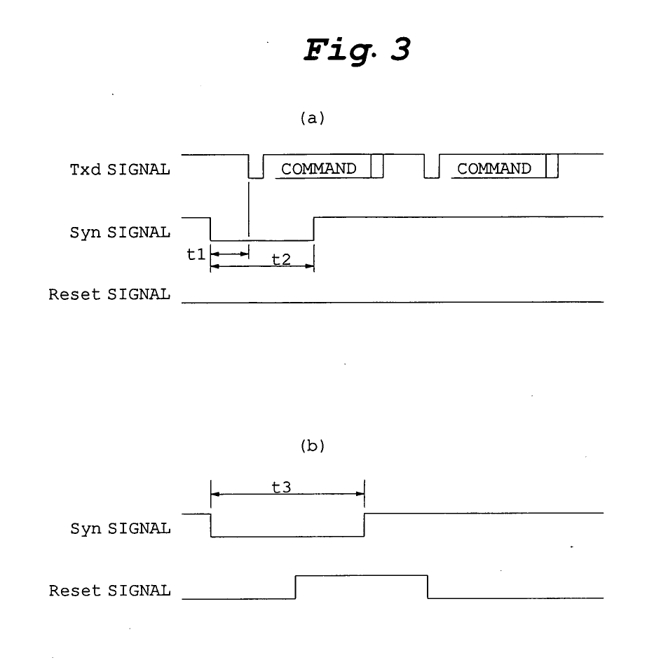

FIG. 4 is a circuit diagram of communication between a terminal control device and a main control device according to a first embodiment of the invention;

FIG. 5 is a circuit diagram of communication between a terminal control device and a main control device according to a second embodiment of the invention;

FIGS. 6(A) and 6(B) are timing charts of communication between the terminal control device and the main control device according to the second embodiment, and FIG. 6(A) is a timing chart at system reset when no rewriting of a control program is performed, and FIG. 3(B) is a timing chart at system reset during the rewriting of the control program;

FIG. 7 is a circuit diagram of communication between a terminal control device and a main control device according to another embodiment of the invention; and

FIG. 8 is a circuit diagram of communication between a terminal control devices and a main control device according to a further embodiment of the invention.

### DETAILED DESCRIPTION OF THE PREFERRED EMBODIMENTS

(Embodiment 1)

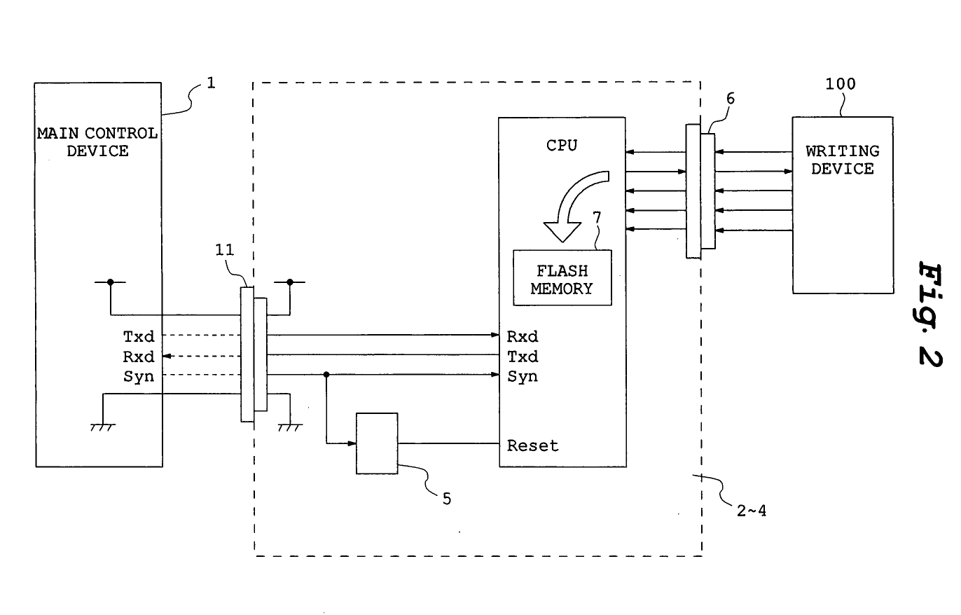

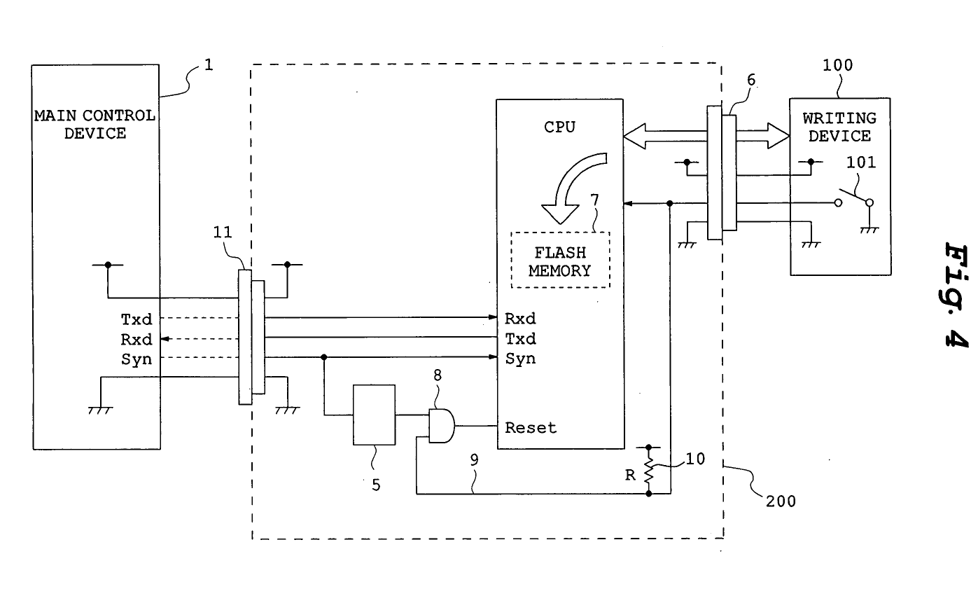

A terminal control device of a vending machine according to a first embodiment of the invention will be described. A terminal control device 200 according to the embodiment includes an AND circuit 8 that connects a system reset circuit 5 and a CPU as shown in FIG. 4. One input terminal of the AND circuit 8 is connected to the system reset circuit 5. The other input terminal of the AND circuit 8 is connectable to one terminal of a switch 101 included in a writing device 100 via a communication line 9 and a data rewrite terminal 6. The other terminal of the switch 101 is grounded. A pullup resistor 10 is connected to the communication line 9 that connects the other input terminal of the AND circuit 8 and the data rewrite terminal 6. An output terminal of the AND circuit 8 is connected to the CPU via a signal line. Except for those mentioned above, a configuration of the terminal control device 200 is the same as a configuration of a conventional terminal control device in FIG. 2.

In the terminal control device 200, when the writing device 100 is not connected, a high signal is input to the other input terminal of the AND circuit 8 by the pullup resistor 10. Thus, when a Syn signal as a system reset signal is output from a main control device 1, and a Reset signal output from the system reset circuit 5 goes high according to the Syn signal as the system reset signal, the AND circuit 8 opens to transmit the high Reset signal to the CPU, and the CPU is reset.

When the writing device 100 is connected to the terminal control device 200, and the switch 101 is manually turned on, the effect of the pullup resistor 10 is eliminated to input a low signal to the other input terminal of the AND circuit 8. Therefore, even if the Syn signal as the system reset signal is output from the main control device 1, and the Reset signal output from the system reset circuit 5 goes high according to the Syn signal as the system reset signal, the AND circuit 8 does not open, and thus the high Reset signal is not transmitted to the CPU, and the CPU is not reset.

If the switch 101 stays ON, the AND circuit 8 closes to disable the Syn signal output as the system reset signal from the main control device 1 even during the rewriting of the control program, and thus the CPU is reset to eliminate the possibility of making the terminal control device 200 inoperable.

(Embodiment 2)

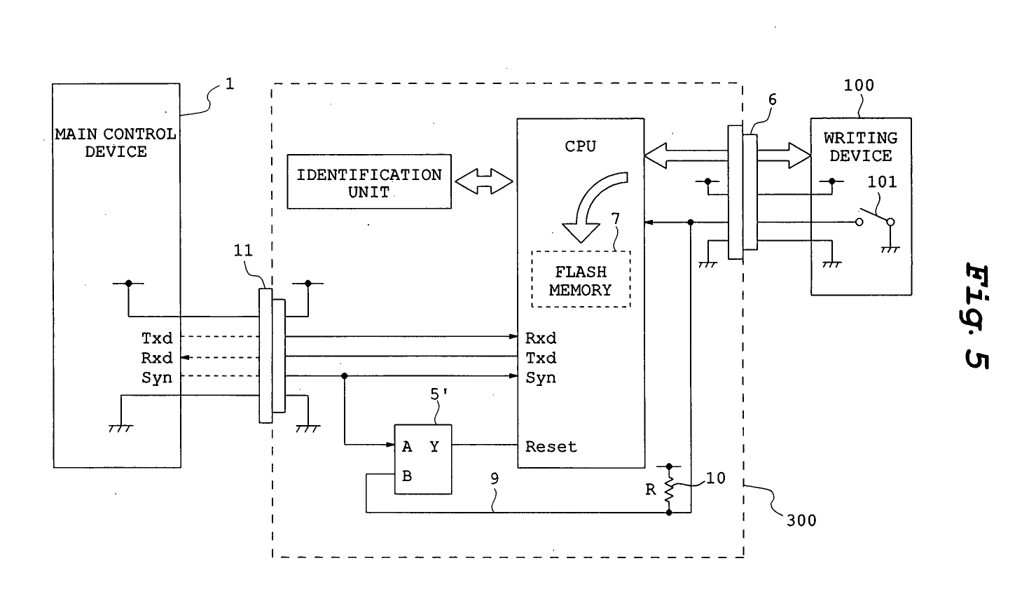

A terminal control device of a vending machine according to a second embodiment of the invention will be described. As shown in FIG. 5, a terminal control device 300 according to the embodiment includes a delay system reset circuit 5′ instead of the system reset circuit 5 and the AND circuit 8. A Syn signal from a main control device 1 is input to one input terminal A of the delay system reset circuit 51, like the system reset circuit 5. The other input terminal B of the delay system reset circuit 5′ is connectable to a switch 101 included in a writing device 100 via a communication line 9 and a data rewrite terminal 6. A pullup resistor 10 is connected to the communication line 9 that connects the other input terminal of the delay system reset circuit 5′ and the data rewrite terminal 6. An output terminal Y of the delay system reset circuit 5′ is connected to a CPU via a signal line.

When a high signal is input to the input terminal B, and a Syn signal as a system reset signal is input from the main control device 1 to the input terminal A, the delay system reset circuit 5′ outputs a high Reset signal. On the other hand, when a low signal is input to the input terminal B, and the Syn signal as the system reset signal is input from the main control device 1 to the input terminal A, the delay system reset circuit 5′ does not output the high Reset signal, but outputs the high Reset signal after the low signal input to the input terminal B turns to a high signal. Except for those mentioned above, a configuration of the terminal control device 300 is the same as the configuration of the terminal control device 200 in FIG. 4.

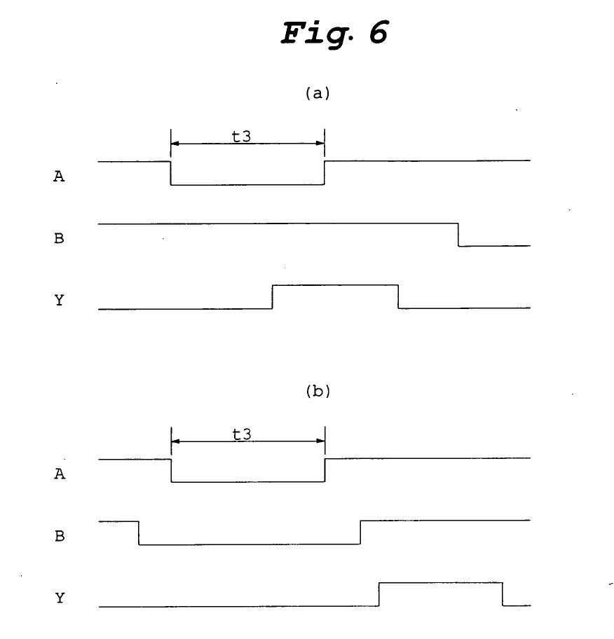

In the terminal control device 300, when the writing device 100 is not connected, a high signal is input to the input terminal B of the delay system reset circuit 5′ by the pullup resistor 10 as shown in FIG. 6(A). Thus, when a Syn signal as a system reset signal is input from the main control device 1 to the input terminal A, a Reset signal output from the output terminal Y of the delay system reset circuit 5′ goes high, the high Reset signal is transmitted to the CPU, and the CPU is reset.

When the writing device 100 is connected, and the switch 101 is manually turned on, the effect of the pullup resistor 10 is eliminated to input a low signal to the input terminal B of the delay system reset circuit 5′ as shown in FIG. 6(B). Therefore, even if the Syn signal as the system reset signal is input from the main control device 1 to the input terminal A, the Reset signal output from the output terminal Y of the delay system reset circuit 5′ is kept low.

If the switch 101 stays ON, there is no possibility that the CPU is reset even during the rewriting of the control program stored in a flash memory 7 using the writing device 100. When the switch 101 is turned off or the writing device 100 is removed after the rewriting of the control program, the pullup resistor 10 is operated to cause the low signal input to the input terminal B of the delay system reset circuit 5′ to turn to a high signal. This causes the Reset signal output from the output terminal Y to go from low to high, and the CPU is reset. Because the rewriting of the control program is already completed, the reset of the CPU does not make the terminal control device 300 inoperable.

As is evident from the above description, in the terminal control device 300, the generation of the effect of the Syn signal output as the system reset signal from the main control device 1 is delayed by the delay system reset circuit 5′, thus preventing occurrence of the situation where the CPU is reset during the rewriting of the control program to make the terminal control device 300 inoperable.

The embodiments of the invention have been described, but the invention is not limited to them. The scope of the invention is defined by accompanying claims, and the invention covers all variants included in meaning of the claims. Variants will be now described.

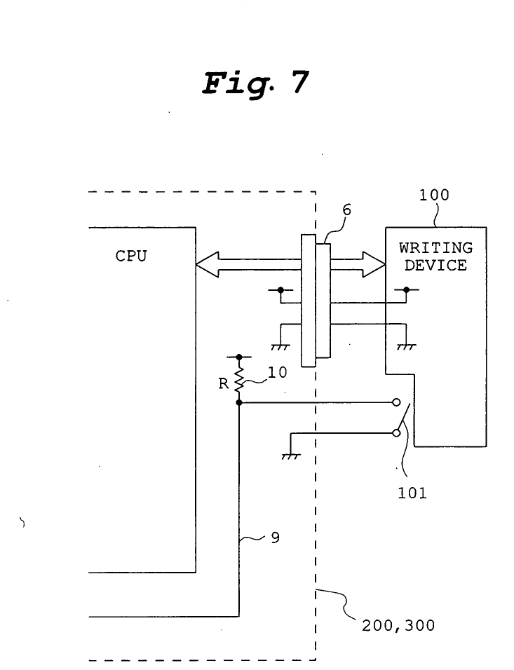

In the terminal control device 200 or 300, as shown in FIG. 7, a switch 101 may be provided in the terminal control device 200 or 300 instead of the writing device 100 so that the switch 101 engages the writing device 100 to be turned on when the writing device 100 is connected to the terminal control device 200 or 300.

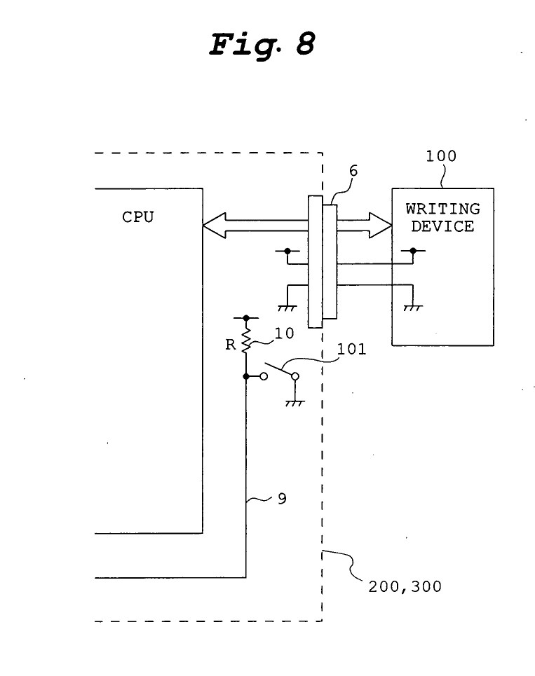

In the terminal control device 200 or 300, as shown in FIG. 8, a switch 101 may be provided in the terminal control device 200 or 300 instead of the writing device 100, and the switch 101 may be manually turned on.

When the writing device 100 is connected, a terminal control device that detects the connection may transmits a detection signal to a main control device 1, which may disable generation of a Syn signal as a system reset signal, or delay the generation of the Syn signal as the system reset signal until the writing device 100 is disconnected.

During the rewriting of the control program of the terminal control device, in addition to the disabling or the delay of the Syn signal as the system reset signal transmitted by the main control device, an interrupt handling signal by a watchdog timer that is operated when a system runs away to reset a CPU of the terminal control device, or an interrupt handling signal such as a non-maskable interrupt that is operated when power fails to reset the CPU of the terminal control device may be disabled using an AND circuit like the terminal control device 200. This prevents occurrence of an inconvenient situation such as a malfunction of a device caused by interrupt handling during the rewriting of the control program of the terminal control device.

1. A terminal control device of a vending machine that comprises storage means capable of electrical data rewrite, connects to a main control device in a master/slave communication system, and can rewrite a control program stored in said storage means using a writing device,
wherein the terminal control device further comprises disabling means for disabling a system reset signal output from the main control device.

2. The terminal control device of a vending machine according to claim 1, wherein the terminal control device further comprises a starting switch for starting the disabling means, and the starting switch engages the writing device to be turned on when the writing device is connected to the terminal control device.

3. The terminal control device of a vending machine according to claim 1, wherein the terminal control device further comprises a starting switch for starting the disabling means, and the starting switch is manually turned on.

4. The terminal control device of a vending machine according to claim 1, wherein the disabling means is started by manually turning on the starting switch included in the writing device.

5. A terminal control device of a vending machine that comprises storage means capable of electrical data rewrite, connects to a main control device in a master/slave communication system, and can rewrite a control program stored in said storage means using a writing device,
wherein the terminal control device further comprises delay means for delaying generation of an effect of a system reset signal output from the main control device.

6. The terminal control device of a vending machine according to claim 5, wherein the terminal control device further comprises a starting switch for starting the delay means, and the starting switch engages the writing device to be turned on when the writing device is connected to the terminal control device.

7. The terminal control device of a vending machine according to claim 5, wherein the terminal control device further comprises a starting switch for starting the delay means, and the starting switch is manually turned on.

8. The terminal control device of a vending machine according to claim 5, wherein the delay means is started by manually turning on the starting switch included in the writing device.

9. A terminal control device of a vending machine comprising:
a first interface that connects to a main control device in a master/slave communication system;
storage means capable of electrical data rewrite;
arithmetic operation means for executing a control program stored in the storage means and resetting an operation by a system reset signal output from the main control device;
a second interface that connects to a writing device for rewriting the control program; and
disabling means for disabling a system reset signal output from the main control device, or delay means for delaying generation of an effect of the system reset signal.
